(19) United States
(12) Patent Application Publication
(10) Pub. No.: US 2016/0063360 A1
(43) Pub. Date: Mar. 3, 2016

(54) IMAGE FORMING APPARATUS WITH FUNCTION AND IMAGE SELECTION

(71) Applicants: KABUSHIKI KAISHA TOSHIBA, Tokyo (JP); TOSHIBA TEC KABUSHIKI KAISHA, Tokyo (JP)

(72) Inventor: DAYONG CHEN, Sagamihara (JP)

(21) Appl. No.: 14/469,455

(22) Filed: Aug. 26, 2014

(51) Int. Cl. G06K 15/00; G06K 15/02

(52) U.S. Cl. CPC G06K 15/002; G06K 15/02

(57) ABSTRACT

An image forming apparatus includes a display unit and a controller in communication with the display unit. The controller is configured to receive a selection of a function to be executed among a plurality of functions executable with respect to image data, generate a display to be displayed on the display unit, the display including a plurality of selectable items, each corresponding to an image data, receive a selection of one of the selectable items, and control execution of the selected function with respect to the selected image data.

### FIELD

Embodiments described herein relate generally to an image forming apparatus.

### BACKGROUND

An image forming apparatus such as a multi function peripheral (MFP) has a plurality of functions such as copying, scanning, faxing, and the like.

When the plurality of functions of the image forming apparatus are used with respect to the same page of an original document, it is necessary for a user to scan the same page a plurality of times according to the number of functions. For this reason, there is a possibility that effort, time, and energy resources may be wasted when the user uses the plurality of functions of the image forming apparatus.

### DESCRIPTION OF THE DRAWINGS

FIG. 1 is a perspective view of an image forming apparatus according to an embodiment.

FIG. 2 is a diagram which illustrates an example configuration of the image forming apparatus according to the embodiment.

FIG. 3 illustrates an example of a display generated by an output unit, according to an aspect of the embodiment.

FIG. 4 illustrates an example of a data table, according to an aspect of the embodiment.

FIG. 5 an example of a processing flow of the image forming apparatus according to the embodiment.

### DETAILED DESCRIPTION

An image forming apparatus includes a display unit and a controller in communication with the display unit. The controller is configured to receive a selection of a function to be executed among a plurality of functions executable with respect to image data, generate a display to be displayed on the display unit, the display including a plurality of selectable items, each corresponding to an image data, receive a selection of one of the selectable items, and control execution of the selected function with respect to the selected image data.

Hereinafter, the image forming apparatus according to the embodiment will be described with reference to drawings.

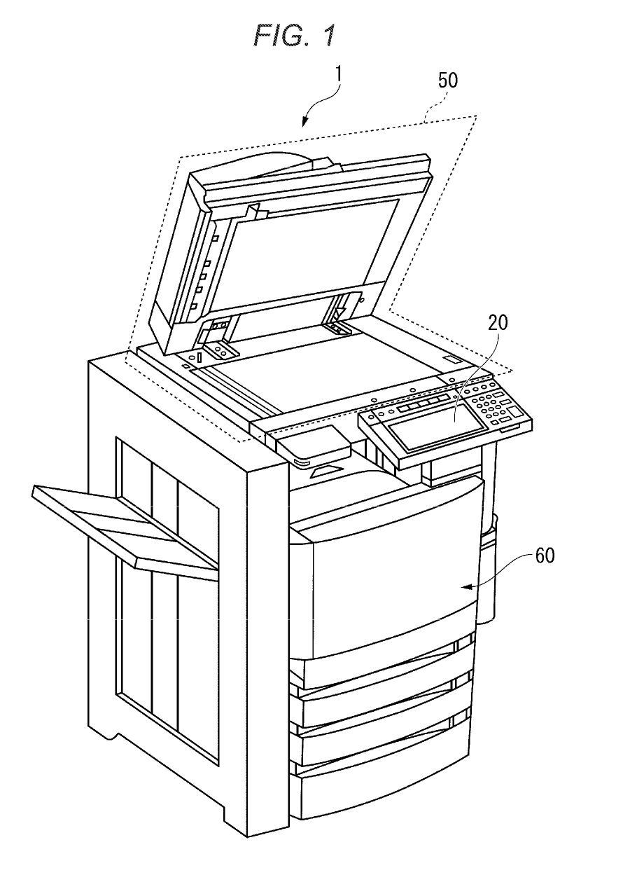

FIG. 1 is a perspective view of an image forming apparatus 1 according to the embodiment. The image forming apparatus 1 generates image data (digital data) by reading an image. For example, the image forming apparatus 1 is an MFP.

The image forming apparatus 1 includes an output unit 20, a scanning unit 50, and a printing unit 60. The image forming apparatus 1 may be, for example, an ink jet image forming apparatus or an image forming apparatus which fixes a toner image.

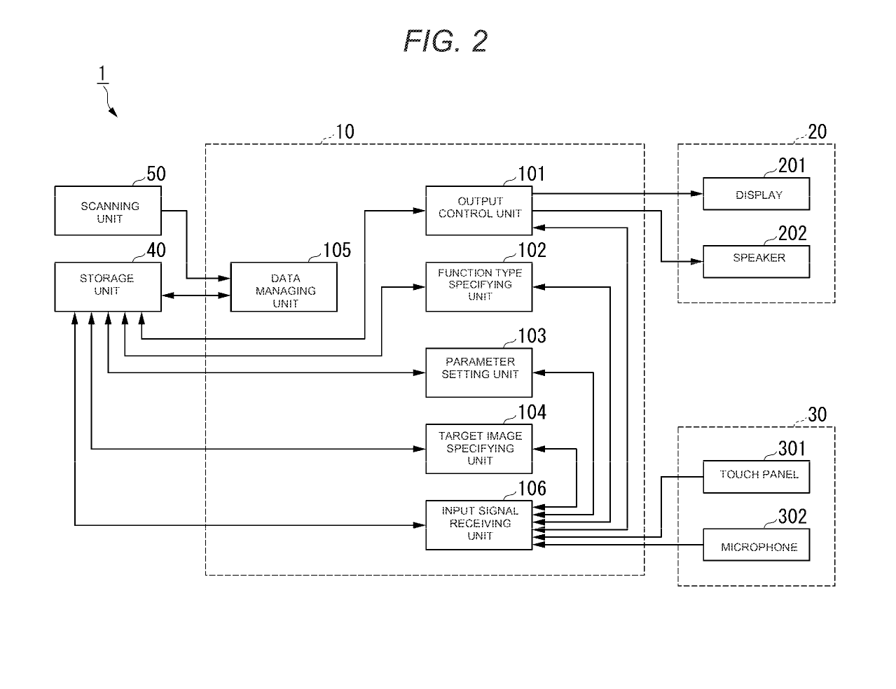

FIG. 2 illustrates an example configuration of the image forming apparatus 1 according to the embodiment. The image forming apparatus 1 includes a controller 10, the output unit 20, an input unit 30, a storage unit 40, the scanning unit 50, and the printing unit 60.

The controller 10 includes an output control unit 101, a function type specifying unit 102, a parameter setting unit 103, a target image specifying unit 104, a data managing unit 105, an input signal receiving unit 106. In one embodiment, the controller 10 is a processor and the various units 101-106 are implemented as software running on the processor. In addition, the controller 10 controls execution of various functions of the image forming apparatus 1, including copying, scanning, faxing, printing, emailing, network transmission, and the like. The output control unit 101 controls outputs of a display unit 201 and a speaker 202 (which are included in the output unit 20). The output control unit 101 causes a preview to be displayed on the display unit 201. The preview is a preview of an image which is generated when the scanning unit 50 performs scanning (hereinafter, referred to as “scanned image”). The output control unit 101 causes the output unit 20 to output a menu for specifying a type of a function which will be executed. The output control unit 101 sets parameter data of a function which will be executed. The output control unit 101 causes the output unit 20 to output a menu which will be used. The menu is a menu for specifying an image, among multiple scanned images, which will be a target of a function.

The function type specifying unit 102 specifies a function which will be executed from among a plurality of functions with respect to image data, based on a user operation with respect to the menu which is output from the output unit 20. For example, the plurality of functions include copying, scanning, faxing, printing, emailing, network transmission, and the like.

The parameter setting unit 103 sets a parameter for the function to be executed, based on the user operation with respect to the menu which is output from the output unit 20.

The target image specifying unit 104 specifies an image which is a target of the specified function, based on the user operation.

The data managing unit 105 removes a scanned image from the storage unit 40 after storing the scanned image in the storage unit 40 for a certain period of time.

The input signal receiving unit 106 may send a command signal to the output control unit 101 based on an input signal received from the input unit 30. The input signal receiving unit 106 may send the command signal to the function type specifying unit 102 based on the input signal. The input signal receiving unit 106 may send the command signal to the parameter setting unit 103 based on the input signal. The input signal receiving unit 106 may send the command signal to the target image specifying unit 104, based on the input signal.

The output unit 20 includes the display unit 201 and the speaker 202.

The speaker 202 provides notification of operations of the menu using synthetic sound based on a control of the output control unit 101. The menu specifies a type of a function which will be executed. The speaker 202 provides notification when the menu is used for setting a parameter of a function to be executed, using synthetic sound based on a control of the output control unit 101. In addition, the speaker 202 provides notification when the menu is used for specifying a scanned image which is an execution target using synthetic sound, based on a control of the output control unit 101.

The input unit 30 includes a touch panel 301 and a microphone 302. The touch panel 301 sends an input signal corresponding to a user operation to the input signal receiving unit 106. The microphone 302 also sends an input signal corresponding to a user's voice to the input signal receiving unit 106.

The storage unit 40 is a storage unit which stores various pieces of information which are necessary for processing in the image forming apparatus 1. For example, the storage unit 40 stores a data table T1.

The scanning unit 50 generates image data by scanning an image.

The printing unit 60 forms an image on a sheet using a recording agent. The recording agent is, for example, toner, ink, an ink ribbon, or the like.

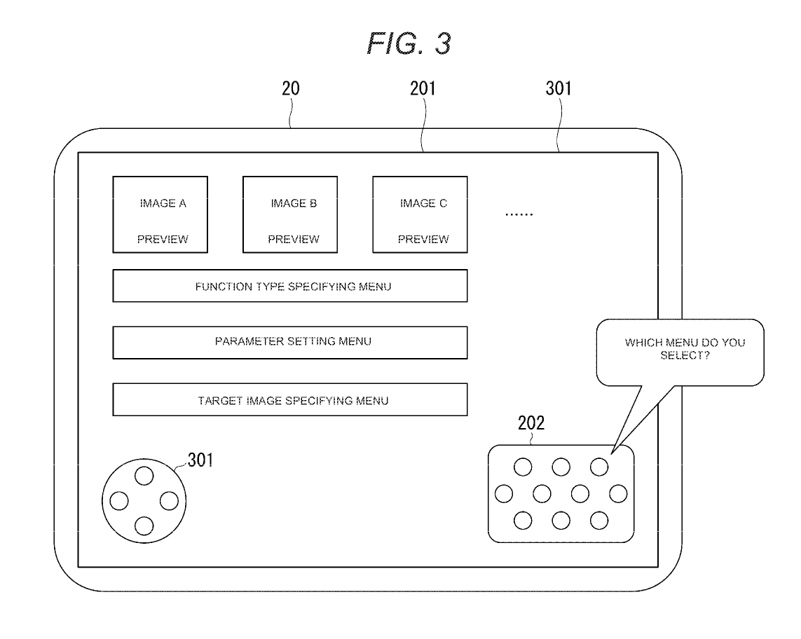

FIG. 3 illustrates an example of a display generated by the output unit 20.

The output unit 20 provides various information to the user. For example, the display unit 201 may display a preview of a scanned image. The display unit 201 may display a function type specifying menu. The function type specifying menu is a menu for specifying a type of a function to be executed. The display unit 201 may display a parameter setting menu. The parameter setting menu is a menu for setting a parameter of a function to be executed. In addition, the display unit 201 may display a target image specifying menu. The target image specifying menu is a menu for specifying an image which is an execution target of a function among scanned images. In addition, the speaker 202 may play an input request such as “Which menu do you select?” using synthetic sound.

FIG. 3 also illustrates the touch panel 301 and the input unit 30 of the speaker 202. A user may select various menus by performing operations with respect to the input unit 30. The various menus include the function type specifying menu, the parameter setting menu, and the target image specifying menu.

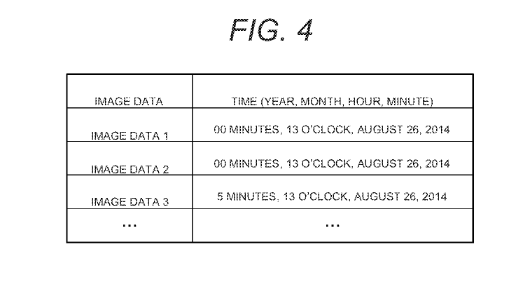

FIG. 4 is a diagram which illustrates an example of the data table T1. The data table T1 stores a correspondence between a time of generating the image data and the image data. The time of generating image data is a time at which the scanning unit 50 scans an image.

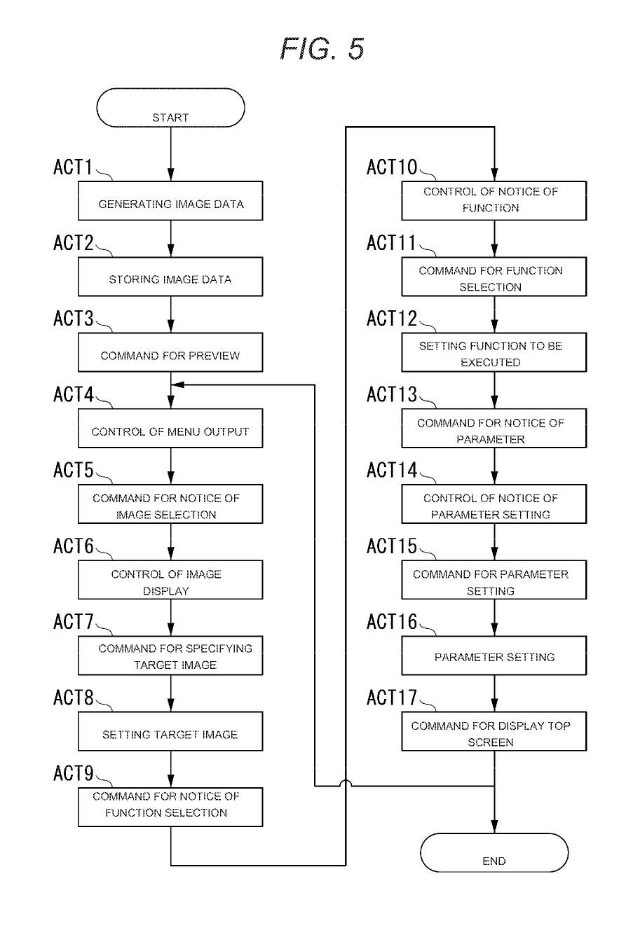

FIG. 5 is a diagram which illustrates an example processing flow of the image forming apparatus 1 according to the embodiment. The processing flow of the image forming apparatus 1 according to the embodiment will be described. The scanning unit 50 generates image data by scanning an image (ACT 1). The scanning unit 50 sends the image data and a time of generating the image data to the controller 10.

The data managing unit 105 which is included in the controller 10 receives the image data and the time of generating the image data from the scanning unit 50. The data managing unit 105 stores the image data and the time of generating the image data in the storage unit 40 (ACT 2).

A user performs an operation with respect to the image forming apparatus 1 in order to view a scanned image. For example, the user may instruct “display a preview of an image” using his or her voice with respect to the microphone 302.

The microphone 302 sends a signal corresponding to the user's voice instructing “display of a preview of an image” to the input signal receiving unit 106.

The input signal receiving unit 106 receives the input signal corresponding to the user operation from the input unit 30. The input signal receiving unit 106 analyzes the input signal, and determines what kind of instruction the input signal denotes. The input signal receiving unit 106 sends a command signal to any one of each of the functional units according to the instruction the input signal denotes. The functional units are the output control unit 101, the function type specifying unit 102, the parameter setting unit 103, and the target image specifying unit 104.

For example, the input signal receiving unit 106 receives an input signal corresponding to the instruction “display a preview of an image” from the microphone 302 which is included in the input unit 30. The input signal receiving unit 106 analyzes the input signal. The input signal receiving unit 106 specifies that the input signal is a signal which instructs an image display, based on the analyzing result. The input signal receiving unit 106 sends a preview command signal to the output control unit 101 according to the instruction “display a preview of an image” which is denoted using the input signal. The preview command signal is a signal for displaying a preview of an image.

Here, a case in which the output control unit 101 receives a preview command signal from the input signal receiving unit 106 will be taken into consideration.

The output control unit 101 receives a preview command signal from the input signal receiving unit 106 (ACT 3: preview command). The output control unit 101 accesses the storage unit 40. The output control unit 101 reads the data table T1 from the storage unit 40. For example, the data table T1 is the data table T1 which is illustrated in FIG. 4. The output control unit 101 sends various menus corresponding to the read data table T1 to the output unit 20 (menu output control) (ACT 4). For example, the output control unit 101 may cause the display unit 201 to display a preview of an image. The output control unit 101 may cause the display unit 201 to display a function type specifying menu. The output control unit 101 may cause the display unit 201 to display a parameter setting menu. The output control unit 101 may cause the display unit 201 to display a target image specifying menu. The preview of the image, the function type specifying menu, the parameter setting menu, and the target image specifying menu which are displayed on the display unit 201 are example displays, and example of which is denoted in FIG. 3. In addition, for ease of description, a screen on which the preview of the image, the function type specifying menu, the parameter setting menu, and the target image specifying menu are displayed will be referred to as a top screen.

A user selects a menu among the function type specifying menu, the parameter setting menu, and the target image specifying menu which are displayed on the display unit 201. For example, the user touches a display position of the target image specifying menu on the display unit 201. The input unit 30 sends an input signal to the input signal receiving unit 106 according to an operation in which the target image specifying menu is selected with respect to the input unit 30. Here, the input signal is a signal which denotes a detail of the target image specifying menu. The touch panel 301 sends the input signal to the input signal receiving unit 106 according to a response of a sensor corresponding to the position which is touched by the user. The input signal receiving unit 106 sends a command signal to notify the output control unit 101 of the image selection, according to the input signal. The command signal here is a signal to notify a user to select a target image. The output control unit 101 receives the command signal from the input signal receiving unit 106 (ACT 5: command signal for notifying of image selection). The output control unit 101 causes the display unit 201 to display a screen for selecting a target image according to the command signal for notifying of image selection (ACT 6: image display control).

The user selects a target image on the screen on which the target image is displayed on the display unit 201. For example, the user inputs target image pages such as “pages 2 to 4 and page 8”. The user may select the target image by touching a preview which is displayed on the display unit 201.

The input unit 30 sends the input signal to the input signal receiving unit 106 according to an operation for selecting a target image with respect to the input unit 30. Here, the input signal is a signal which denotes the selected target image.

The input signal receiving unit 106 sends a command signal for specifying target image to the target image specifying unit 104 according to the input signal. The command signal here is a signal for specifying a selected target image as an execution target of a function.

The target image specifying unit 104 receives the command signal from the input signal receiving unit 106 (ACT 7: command for specifying target image). The target image specifying unit 104 sets a selected target image to an execution target of a function according to the command signal (setting of target image) (ACT 8).

In addition, the input signal receiving unit 106 sends a command signal for notification of the function selection to the output control unit 101 according to the input signal. The command signal here is a signal for notifying the user to select a function to be executed with respect to the selected target image.

The output control unit 101 receives the command signal from the input signal receiving unit 106 (ACT 9: command for notifying of function selection). The output control unit 101 causes the output unit 20 to output information prompting the user to select a function to be executed according to the command signal for notification of function selection (ACT 10: function selection notification control). For example, the display unit 201 displays buttons for selecting a function, along with characters such as “Please selects a function to be executed”. The function may be a function such as copying, scanning, and faxing.

The user selects a function to be executed with respect to the input unit 30. For example, the user uses buttons for selecting functions such as copying, scanning, and faxing which are displayed on the display unit 201.

The input unit 30 sends an input signal to the input signal receiving unit 106 according to an operation for selecting a function to be executed with respect to the input unit 30. Here, the input signal is a signal which denotes a type of a function to be selected.

The input signal receiving unit 106 sends a command signal for selecting function to the target image specifying unit 104 according to the input signal. The command signal here is a signal for executing a selected function.

The target image specifying unit 104 receives the command signal from the input signal receiving unit 106 (ACT 11: command for selecting function). The target image specifying unit 104 sets the selected function as a function to be executed according to the command signal (ACT 12: setting function to be executed).

The input signal receiving unit 106 sends a command signal for notifying of parameter setting to the output control unit 101 according to the input signal. The command signal here is a signal for informing a user so as to set a parameter of a function to be executed.

The output control unit 101 receives the command signal from the input signal receiving unit 106 (ACT 13: command for notifying of parameter setting). The output control unit 101 causes the output unit 20 to output information prompting the user to set a parameter according to the command signal for notifying of parameter setting (ACT 14: control of informing of parameter setting). For example, the display unit 201 displays buttons along with characters denoting “Please set a parameter”. The buttons are buttons for selecting a type of a parameter corresponding to each function such as color printing, monochrome printing, a destination device of transmission, or the like. In addition, the buttons are buttons for selecting a degree of a parameter corresponding to each function such as the color printing, the monochrome printing, the destination device of transmission, or the like.

A user sets a parameter with respect to the input unit 30. For example, the user selects a sheet size to be scanned using a setting button which is displayed on the display unit 201.

The input unit 30 sends an input signal to the input signal receiving unit 106 according to an operation which sets a parameter with respect to the input unit 30. Here, the input signal is a signal denoting a set parameter.

The input signal receiving unit 106 sends a command signal for setting parameter to the target image specifying unit 104 according to the input signal. The command signal here is a signal for setting a parameter which is selected by the user.

The target image specifying unit 104 inputs the command signal for setting parameter from the input signal receiving unit 106 (ACT 15: command for parameter setting). The target image specifying unit 104 sets a parameter according to the command signal for setting parameter (ACT 16: setting parameter).

The input signal receiving unit 106 sends a command signal for top screen displaying to the output control unit 101 according to the input signal. The command signal for top screen displaying is a signal for instructing a display of the top screen.

The output control unit 101 receives the command signal for top screen displaying from the input signal receiving unit 106 (ACT 17: command for top screen display). The output control unit 101 returns to the processing in ACT 4 in which the output unit 20 is caused to output the top screen, according to the command signal for top screen displaying. A user selects the above described target image again from the top screen which is displayed on the display unit 201. The user selects a function to be executed. The user selects a parameter.

By doing so, a user is able to reuse the scanned image data which is stored in the storage unit 40 without performing rescanning with respect to the plurality of functions. The plurality of functions are copying, scanning, faxing, and the like.

In addition, the image forming apparatus 1 may not include the scanning unit 50. The image forming apparatus 1 may reuse the scanned image data which is stored in the storage unit 40 with respect to the plurality of functions. The storage unit 40 may store scanned image data which is scanned using a different apparatus from the image forming apparatus 1. In addition, the storage unit 40 may remove scanned image data when a predetermined condition is satisfied. For example, the storage unit 40 stores scanned image data, and may remove the scanned image data after a certain period of time.

In addition, the storage unit 40 according to the embodiment may be provided in any place in a range in which appropriate transceiving of information is performed. In addition, a plurality of the storage units 40 may be provided in the range in which appropriate transceiving of information is performed. In addition, the storage unit 40 may store data that is transmitted in the range in which appropriate transceiving of information is performed.

In addition, the order of processing in the embodiment may be switched as deemed appropriate in the implementation and/or operation by the user.

According to the image forming apparatus 1 in at least one of the embodiments which are described above, a user is able to use scanned image data which is stored in the storage unit 40 in a plurality of functions.

In addition, a computer system may be included in the above described controller 10 and the image forming apparatus 1. In addition, the process of the above described processing is stored in a computer readable recording medium in a program format. When a computer reads and executes the program, the above described processing is performed. Here, as the computer readable recording medium, there are a magnetic disk, a magneto-optical disk, a CD-ROM, a DVD-ROM, a semiconductor memory, and the like. In addition, the computer program may be delivered to a computer using a communication line, and the computer to which the program is delivered executes the program.

In addition, the above described program may be a program for executing a portion of the above described functions. In addition, the above described functions may be executed by combining the above described program with a program which is stored in the computer system in advance. That is, the above described program may be a so-called difference file (difference program).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image forming apparatus comprising:
a storage unit configured to store a plurality of image data;
a display unit; and
a controller in communication with the display unit, the controller configured to:
receive a first signal specifying image data stored in the storage unit, the image data being selected via the display unit,
receive a second signal, via the display unit, specifying one of a plurality of functions executable with respect to the specified image data after the first signal specifying image data is received,
receive a third signal specifying at least one of a plurality of selectable items corresponding to the specified function,
receive a fourth signal specifying a parameter setting corresponding to the specified item, and
control execution of the specified function based on the received parameter setting with respect to the specified image data.

2-7. (canceled)

8. An image forming method comprising the steps of:
storing a plurality of image data on a storage unit;
receiving a first selection specifying image data stored in the storage unit;
receiving a second selection specifying one of a plurality of functions executable with respect to the specified image data after the first selection specifying image data is received;
receiving a third selection specifying at least one of a plurality of selectable items corresponding to the specified function;
receiving a fourth selection specifying a parameter setting corresponding to the specified item; and
executing the specified function based on the received parameter setting with respect to the specified image data.

9-14. (canceled)

15. A non-transitory computer readable medium storing instructions causing an image forming apparatus to perform the steps of:
receiving a first selection specifying image data stored in a storage unit which stores a plurality of image data;
receiving a second selection specifying one of a plurality of functions executable with respect to the specified image data after the first selection specifying image data is received;
receiving a third selection specifying at least one of a plurality of selectable items corresponding to the specified function;
receiving a fourth selection specifying a parameter setting corresponding to the specified item; and
executing the specified function based on the received parameter setting with respect to the specified image data.

16-20. (canceled)

21. The apparatus according to claim 1, wherein the controller is further configured to
receive a fifth signal specifying another image data stored in the storage unit as a second image data, the second image data being selected via the display unit, and
receive a sixth signal, via the display unit, specifying one of a plurality of functions executable with respect to the second image data after the second image data is specified.

22. The apparatus according to claim 21, wherein the controller is configured to control execution of the specified functions with respect to the first image data and the second image data.

23. The apparatus according to claim 22, further comprising:
a scanner,
wherein the image data stored in the storage unit is image data scanned by the scanner.

24. The apparatus according to claim 22, wherein the controller is configured to output a menu including preview images of the image data for specifying the first and the second image data as an execution target of the specified functions.

25. The method according to claim 8, further comprising:
receiving a fifth selection specifying another image data stored in the storage unit as a second image data; and
receiving a sixth selection specifying one of a plurality of functions executable with respect to the second image data after the second image data is specified.

26. The method according to claim 25, further comprising:
executing the specified functions with respect to the first image data and the second image data.

27. The method according to claim 26, further comprising:
providing a menu including preview images of the image data for specifying the first and the second image data as an execution target of the specified functions.

28. The non-transitory computer readable medium according to claim 15, wherein the instructions further cause the image forming apparatus to perform the step of:
receiving a fifth selection specifying another image data stored in the storage unit as a second image data, and
receiving a sixth selection specifying one of a plurality of functions executable with respect to the second image data after the second image data is specified.

29. The non-transitory computer readable medium according to claim 28, wherein the instructions further cause the image forming apparatus to perform the step of:
executing the specified functions with respect to the first image data and the second image data.

30. The non-transitory computer readable medium according to claim 29, wherein the instructions further cause the image forming apparatus to perform the step of:
providing a menu including preview images of the image data for specifying the first and the second image data as an execution target of the specified functions.
